(19) United States
(12) Patent Application Publication
(10) Pub. No.: US 2015/0085699 A1
(43) Pub. Date: Mar. 26, 2015

(54) ADAPTIVE NETWORK CONFIGURATION

(71) Applicant: QUALCOMM Incorporated, San Diego, CA (US)

(72) Inventors: Sai Yiu Duncan Ho, San Diego, CA (US); Peerapol Tinnakornsrisuphap, San Diego, CA (US); Qingjiang Tian, San Diego, CA (US); Eyal Hochdorf, Palo Alto, CA (US); Xuetao Chen, Fremont, CA (US)

(73) Assignee: QUALCOMM Incorporated, San Diego, CA (US)

(21) Appl. No.: 14/285,062

(22) Filed: May 22, 2014

Related U.S. Application Data
(60) Provisional application No. 61/881,928, filed on Sep. 24, 2013.

(51) Int. Cl. H04W 16/10

(52) U.S. Cl. CPC H04W 16/10
USPC 370/254

(57) ABSTRACT

A network configurator can dynamically configure a device to couple network data between other devices in a wireless network. The devices can include two independent wireless transceivers that can each operate within different frequency bands, such as the 2.4 GHz and 5.0 GHz frequency bands. The configuration of the independent wireless transceivers can be based, at least in part, on device capabilities of the wireless transceivers, channel conditions, and a quality of service associated with the other wireless stations in the wireless network.

### RELATED APPLICATIONS

This application claims the priority benefit of U.S. Provisional Patent Application Ser. No. 61/881,928 filed Sep. 24, 2013.

### BACKGROUND

Embodiments described generally relate to the field of communication systems and, more particularly, to enhanced wireless network coverage within a defined coverage area.

Wireless networks are widely deployed, especially for use in well-defined and limited areas such as homes and apartments. Often, a single wireless access point/router is connected to a cable modem or digital subscriber line (DSL) modem to provide wireless access to a broadband network. Wireless access points can operate in a 2.4 GHz frequency band or in both the 2.4 GHz frequency band and a 5 GHz frequency band. However, these wireless access points may not be able to support the demands of multiple end devices (or stations). In particular, the limited frequencies used by the wireless access points may not support high data throughput rates required by multiple stations.

### SUMMARY

Various embodiments of a first device including a network configurator are disclosed. In one embodiment, the first device includes a first wireless transceiver and a second wireless transceiver. The network configurator determines a first device capability of the first wireless transceiver and a second device capability of the second wireless transceiver. The network configurator also determines a configuration of a second and a third device. The first wireless transceiver is configured to couple network data between the first device and the second device based, at least in part, on the first device capability and the configuration of the second device. The second wireless transceiver is configured to couple network data between the first device and the third device based, at least in part, on the second device capability and the configuration of the third device.

### BRIEF DESCRIPTION OF THE DRAWINGS

The present embodiments may be better understood, and numerous objects, features, and advantages made apparent to those skilled in the art by referencing the accompanying drawings.

FIG. 1 is an example system diagram of a wireless network configured by a network configurator.

FIG. 2 is a flow diagram illustrating example operations for dynamically selecting network data pathways in a wireless network

FIG. 3 is a flow diagram illustrating another embodiment of example operations for configuring a wireless device in a wireless network.

FIG. 4 is an example block diagram of a dual band, dual concurrent range extender.

FIG. 5 is a block diagram of an embodiment of an electronic device including a network configurator.

### DESCRIPTION OF EMBODIMENT(S)

The description that follows includes exemplary systems, methods, techniques, instruction sequences, and computer program products that embody techniques of the present disclosure. However, it is understood that the described embodiments may be practiced without these specific details. For instance, although examples refer to wireless systems in compliance with IEEE 802.11 specifications, in some implementations other wireless, wired or hybrid systems can be used. In other instances, well-known instruction instances, protocols, structures, and techniques have not been shown in detail in order not to obfuscate the description.

A wireless network in a home, apartment, or other area can include a central access point (CAP) that provides wireless access to a broadband network. The CAP can couple to the broadband network through, for example, a cable or DSL network connection. Stations in the wireless network can establish a link to the CAP to access the broadband network. The CAP, however, may not be able to provide uniform wireless access for the stations. As wireless signals propagate further away from the CAP, wireless signal strength decreases. In areas of weak signal strength, a station may not be able to establish a link to the CAP. In different circumstances, even if a link can be established, the weak signal strength present at the station may not support high data throughput rates.

Range extenders (REs) can be used to extend coverage throughout the wireless network. An RE can extend network coverage by receiving, buffering and then relaying data to and from the CAP. However, range extenders are often limited to receiving and relaying data through a single frequency band. In some cases, adding an RE to the wireless network can reduce data throughput by approximately 50% since the frequency band is reused by the RE. Thus, the RE can increase wireless network coverage, but can substantially reduce data throughput rates. When multiple client devices (stations or STAs) are coupled to the wireless network and the STAs demand high data throughput rates, the REs may fail to supply the desired data throughput rate due to the frequency reuse.

Wireless network coverage and data throughput rates can be improved by selecting network data pathways between the CAP, the REs, and the STAs. In one embodiment, the network data pathway selection can be provided by configuring the wireless network (e.g., configuring wireless devices in the wireless network) based, at least in part, on channel conditions. The wireless network configuration can also be based on a desired quality of service associated with one or more STAs in the wireless network. In some embodiments, the CAP or the REs can shape data traffic to the STAs to help balance network loading and enable the wireless network to provide the desired quality of service for the STAs.

In some embodiments, to increase network data pathway choices and improve connectivity and coverage, the CAP and the REs can be implemented as dual band, dual concurrent (DBDC) devices. A DBDC device can include two transceivers and can operate on two different frequency bands simultaneously. For example, a DBDC CAP can include a first transceiver configured to operate within the 2.4 GHz frequency band and a second transceiver configured to operate within the 5 GHz frequency band. The first and the second transceivers can operate independently and simultaneously. The two transceivers can also be linked within the DBDC device such that network data can be sent between the transceivers. Since the CAP and the REs are DBDC devices, additional network data pathway selections are possible. Thus, adjacent REs or STAs that may be interfering with each other can be configured to operate on other frequency bands to reduce or eliminate interference. Reducing inter-device interference can increase data throughput rates for the STAs in the wireless network. In some embodiments, a hybrid network can support both wired and wireless communication technologies, multiple wired communication technologies, or multiple wireless communication technologies. For example, the CAP and/or the REs can support both IEEE 802.11 and powerline communication protocols. In other examples, the CAP and/or the REs can support a combination of IEEE 802.11 and powerline communication protocols, a combination of IEEE 802.11 and coaxial cable (Coax) based communication protocols, a combination of long-term evolution (LTE) and IEEE 802.11 communication protocols, a combination of IEEE 802.11 and Bluetooth communication protocols, and various other suitable combinations. Thus, the network data pathways in the hybrid network can include wired and wireless communication technologies.

In some embodiments, the wireless network can be configured by a network configurator. The network configurator can determine channel conditions and a desired quality of service for the STAs in the wireless network. The network configurator can configure the wireless network by configuring the CAP and the REs to operate within particular frequencies. The network configurator can modify the wireless network configuration when a current quality of service for the STAs is less than the desired quality of service. In some embodiments, the network configurator can be implemented within the CAP or within one of the REs in the wireless network.

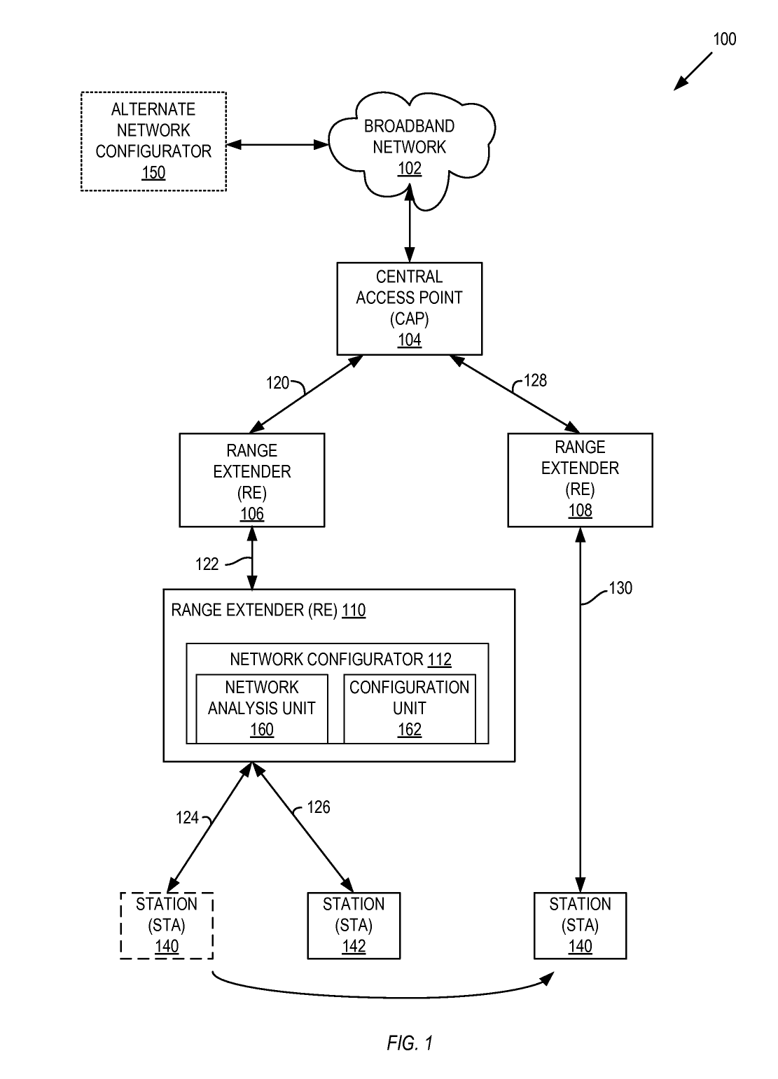

FIG. 1 is an example system diagram of a wireless network 100 configured by a network configurator 112. The wireless network 100 can include a CAP 104, an RE 106, an RE 108, and an RE 110. As shown, the RE 110 can include the network configurator 112. The wireless network 100 can include a STA 140 and a STA 142. The system diagram of FIG. 1 illustrates example operations of the network configurator 112 and configurations of the wireless network 100 and should not be considered as limiting. In other embodiments, other configurations of the wireless network 100 are possible. For example, different arrangements of the REs 106-110 within the wireless network 100 and different numbers of REs and/or STAs are contemplated.

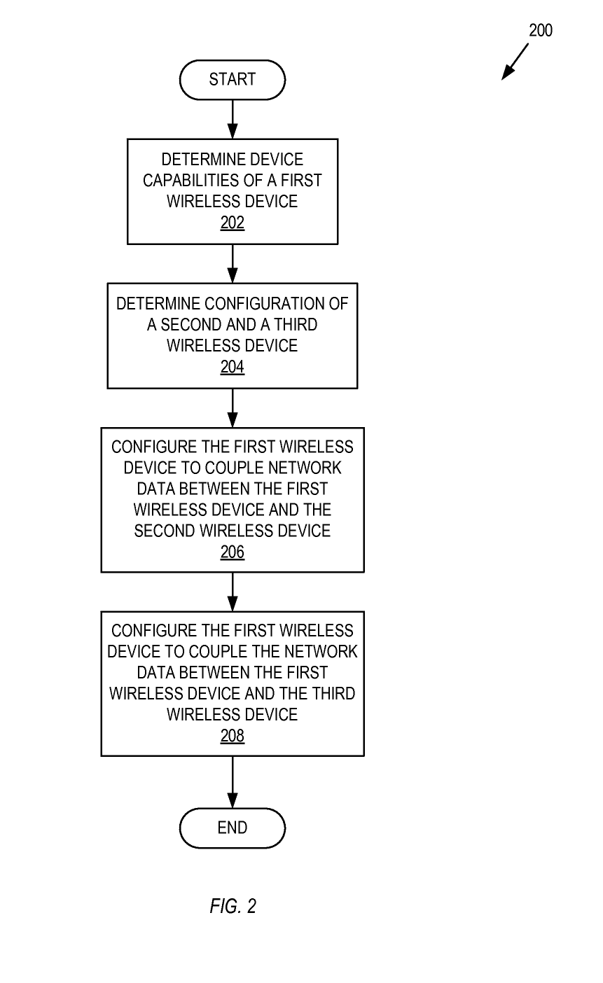

The network configurator 112 can include a network analysis unit 160 and a configuration unit 162. The network analysis unit 160 can determine various channel conditions, wireless device configurations, and wireless device capabilities with respect to the wireless devices (e.g., the CAP 104, STAs 140-142 and/or REs 106-110). The configuration unit 162 can configure the CAP 104 and the REs 106-110 for operations within the wireless network 100. For example, the configuration unit 162 can configure the CAP 104 and the REs 106-110 to communicate using particular operating frequencies. In some embodiments, the network configurator 112 can be distributed between two or more devices in the wireless network, such as within two or more REs or within a CAP and an RE. In another embodiment, the network configurator can be implemented by a remote device coupled to the wireless network through a separate network, such as through the Internet. The network analysis unit 160 and the configuration unit 162 will be described in more detail below and also in conjunction with FIGS. 2-5.

The CAP 104 is communicatively coupled (linked) to a broadband network 102 and can be a DBDC device. For example, the CAP 104 can include a first transceiver and a second transceiver. At least one of the first and the second transceivers can couple to the broadband network 102. Similar to the CAP 104, the REs 106-110 can also be DBDC devices. The REs 106-110 can be positioned throughout a desired coverage area for the wireless network 100. As shown in FIG. 1, the RE 106 is coupled to the CAP 104 through a link 120. Similarly, the RE 110 is coupled to the RE 106 through a link 122 and the RE 108 is coupled to the CAP 104 through a link 128. The links 120, 122 and 128 can represent a frequency band (2.4 GHz or 5 GHz, for example) and a channel within that frequency band can be used to carry network data between two wireless devices. In one embodiment, the CAP 104 and the REs 106-110 can be configured to transmit the network data in accordance with an IEEE 802.11 specification for wireless data transmissions. In another embodiment, the CAP 104 and the REs 106-110 can be configured to transmit the network data in accordance with other wireless specifications, such as a Zigbee® specification, a cellular radio specification, or other technically feasible wireless protocol. The link between the CAP 104 and the broadband network 102 can be referred to as a backhaul link. The backhaul link can couple a wireless device, such as the CAP 104, to other wireless devices or networks that can, in turn, couple to a core or backbone network, such as the Internet. The backhaul link can be a wireless link, a wired link (such as through an Ethernet or powerline connection) or a hybrid link. In some embodiments, a hybrid link can support two or more different communication protocols.

The configuration flexibility of a DBDC wireless device (e.g., the CAP 104 and the REs 106-110), can increase the selection of operating frequencies and channels to link between the CAP 104, the REs 106-110 and the STAs 140-142. For example, the CAP 104 and the REs 106-110 can be configured to avoid congested or busy frequencies and thereby enhance data throughput rates. The frequency and channel selection can also enable the CAP 104 and the REs 106-110 to communicate through links that do not interfere with other links in the wireless network 100. For example, the CAP 104 can transmit and receive network data through a first transceiver operating within the 2.4 GHz frequency band for the link 120 and through a second transceiver operating within the 5 GHz frequency band for the link 128. The RE 106 can be configured to couple to the CAP 104 through the link 120 using the 2.4 GHz frequency band. The RE 108 can be configured to couple to the CAP 104 through the link 128 using the 5 GHz frequency band. In this manner, communications between CAP 104 and RE 108 can have little or no effect on communications between the CAP 104 and the RE 106.

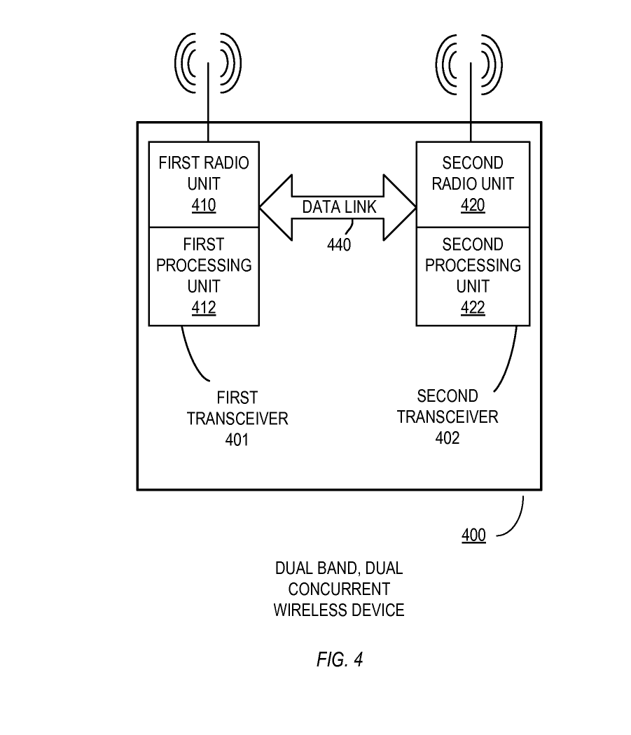

In some embodiments, the DBDC devices can include a data link to couple data, such as network data, between the first transceiver and the second transceiver. For example, the network data can be received through the first transceiver within the 2.4 GHz frequency band and coupled to the second transceiver. The second transceiver can transmit the network data from the first transceiver through the 5 GHz frequency band. Thus, the data link between the first and the second transceivers can provide additional flexibility in determining the network data pathways in the wireless network 100. The data link will be described in more detail below in conjunction with FIG. 4.

The STA 140 (shown with dashed lines) is coupled to the RE 110 through a link 124 and the STA 142 is coupled to the RE 110 through a link 126. In one embodiment, the link 124 and the link 126 can use the same frequency band and channel assigned to the link 122. In another embodiment, the link 124 and the link 126 can use a different frequency band compared to the link 122. For example, the link 122 can be configured to operate within the 2.4 GHz frequency band through a first transceiver in the RE 110. The link 124 can be configured to operate within the 5 GHz frequency band through a second transceiver in the RE 110. The link 126 can be configured to operate in either the 2.4 GHz or the 5 GHz frequency band through either the first or the second transceiver in the RE 110. As depicted, the link 122 is the backhaul link for the RE 110. The other links (the link 124 and the link 126) on the RE 110 can be referred to as serving links. In a similar manner, the link 124 and the link 126 can serve other REs or stations (not shown). The link 128 can be the backhaul link for the RE 108.

Since the REs 106-110 are DBDC devices, the first and second transceivers included in the respective REs can enable many different configurations. For example, an RE can use the 5 GHz frequency band for the backhaul link while using the 2.4 GHz frequency band or both the 2.4 GHz and the 5 GHz frequency bands to couple to the STAs. In another example, the RE can use the 2.4 GHz frequency band for the backhaul link while using the 5 GHz frequency band or both the 2.4 GHz and the 5 GHz frequency bands to couple to the STAs. In still another example, the RE can be configured to use both the 2.4 GHz and the 5 GHz frequency bands for the backhaul link and use the 2.4 GHz frequency band or the 5 GHz frequency band to couple to the STAs. In still another example, the RE can use both the 2.4 GHz and the 5 GHz frequency bands for the backhaul link while coupling to the STAs using both the 2.4 GHz and the 5 GHz frequency bands.

The network configurator 112 can determine the network data pathways by, at least in part, configuring the CAP 104 and the REs 106-110 in the wireless network 100. For example, the network configurator 112 can determine the operating frequencies and channels for the first transceiver and the second transceiver in the RE 106. As described above, the configuration of the CAP 104 and the REs 106-110 can be based, at least in part, on at least one of the channel conditions, the wireless device configurations, the wireless device capabilities, and the quality of service associated with the STAs 140-142.

The channel conditions can include network loading, congestion and usage of operating frequencies and channels that are available to the CAP 104, the REs 106-110 and the STAs 140-142. For example, network loading can describe channel utilization. A heavily loaded network can describe a channel that is near capacity with network data. The channel conditions can also include link data throughput rates. The links within the wireless network 100 can have different data throughput rates. Link data throughput rates can be determined, at least in part, by a distance between the wireless devices (the CAP 104, the REs 106-110 and the STAs 140-142), and a number of wireless devices using the link. The greater the distance between wireless devices, the weaker the receive signal strength. Weak signal strengths are prone to more bit errors. To compensate and reduce the rate of the bit errors, the link data throughput rates can be reduced. Channel conditions can also include receive signal strength indicator (RSSI) measurements for signals received by the REs 106-110 and the CAP 104.

The channel conditions can also include detection of interferers and blockers in and adjacent to available operating frequencies. In one embodiment, the interferers and blockers can be detected through spectral scanning Spectral scanning uses wireless device hardware to scan frequencies in and near operating frequencies and channels that are available to the transceiver. The spectral scanning can determine busy frequencies, interferers, and blockers near frequencies used by the STAs 140-142, the REs 106-110 and the CAP 104. For example, an RE can use spectral scanning to locate beacons or sense traffic within a frequency band. Results of the spectral scan can be provided to the network configurator 112.

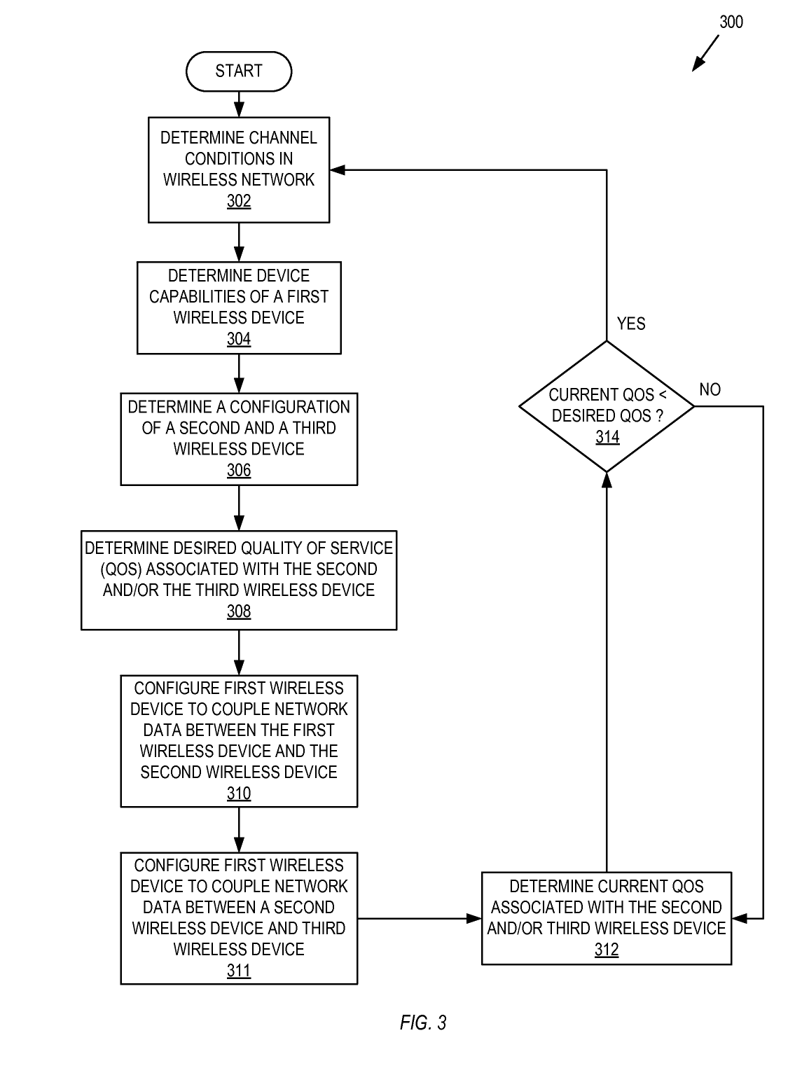

In another embodiment, the channel conditions can be determined partially or entirely by the network analysis unit 160. For example, the network analysis unit 160 can measure and determine the channel conditions described above within the wireless network 100. Alternatively, the network analysis unit 160 can receive channel conditions determined by the CAP 104, the REs 106-110 and the STAs 140-142. The configuration of the wireless devices based, at least in part, on channel condition will be described below in more detail in conjunction with FIGS. 2-3.

As described above, the CAP 104, the REs 106-110 and the STAs 140-142 can be DBDC devices capable of operating within two frequency bands. The network configurator 112 can determine a current configuration and capability of the DBDC devices with respect to the operating frequency bands and links. The network configurator 112 can also determine the configuration and capabilities of non-DBDC devices. In one embodiment, the network analysis unit 160 can determine the wireless device configurations and capabilities for the network configurator 112. For example, the network analysis unit 160 can poll the CAP 104, the REs 106-110 and the STAs 140-142 to determine their respective configurations and capabilities. In another embodiment, the wireless device configurations and capabilities can be stored in a database (not shown). The database can be located in the network configurator 112, in a separate device coupled to one of the REs 106-110 or in another device accessible through the wireless network 100. Thus, the network configurator 112 or the network analysis unit 160 can determine the wireless device configurations and capabilities by accessing the database.

The quality of service (QoS) can describe current and desired performance characteristics associated with the STAs 140-142. As the operating conditions change, the QoS associated with the STAs 140-142 can also change. Example QoS measurements can include signal-to-noise ratio, data throughput rate, bit error rate and data latency time. For example, as the bit error rate within a link decreases, the QoS associated with that link (or a STA coupled to that link) increases. In another example, as a data throughput rate associated with a link increases, the QoS associated with that link (or a STA coupled to that link) increases.

In one embodiment, the desired QoS associated with the STAs 140-142 and can be based, at least in part, on applications running (or planned to run) on their respective STA. Different applications can use data at different rates. For example, the STA 140 can be a tablet computer displaying a movie that is being streamed from a content provider through the broadband network 102. A streaming movie can have a data throughput rate of 6 Megabits per second. Thus, the desired QoS associated with the STA 140 can be 6 Megabits per second. In another example, the STA 142 can be a smart phone being used to display web data from the broadband network 102. Displaying web data can have a data throughput rate of 4 Kilobits per second. In this example, the desired QoS associated with the STA 142 can be 4 Kilobits per second. The configuration of the REs 106-110 can change in response to a changing desired QoS.

In one embodiment, the desired QoS can be determined by the network analysis unit 160. For example, the network analysis unit 160 can measure a QoS associated with a STA and base the desired QoS for the STA on an average of QoS measurements. In another embodiment, a current QoS can be determined by operations of the STA. For example, the current QoS can be determined by measuring the data throughput rate of the STA while in operation. The STA can provide the determined (current) QoS information to the network configurator 112 and/or the network analysis unit 160.

In one embodiment, the CAP 104, the REs 106-110 and the STAs 140-142 can be configured through the configuration unit 162. For example, the transceivers in the CAP 104, the REs 106-110 and the STAs 140-142 can be configured to operate in particular frequency bands, and channels establishing the links 120, 122, 124, 126, 128, and 130. The links 120-130 can form at least a portion of the network data pathways in the wireless network 100.

The network configurator 112 depicted in FIG. 1 is included in the RE 110. In some embodiments, the network configurator 112 can include a processor, memory and communication interfaces (not shown) and can execute program steps to perform operations of the network configurator 112 as described above. In another embodiment, an alternate network configurator 150 (shown with dotted lines) can perform the operations of the network configurator 112, and can be coupled to the CAP 104, the REs 106-110, and the STAs 140-142 through a network connection. In still another embodiment, the network configurator 112 can be included in the CAP 104 or the REs 106-110 included in the wireless network 100. In still another embodiment, the operations of the network configurator 112 can be distributed among multiple wireless devices in the wireless network 100. For example, the network configurator 112 can be distributed between the CAP 104 and the RE 106.

To illustrate an example configuration of the CAP 104 and the REs 106-110 by the network configurator 112, consider the RE 106 configured such that the link 120 operates within the 5 GHz frequency band while the link 122 operates within the 2.4 GHz frequency band. The network configurator 112 can configure the RE 110 coupled to the RE 106 through the link 122 using frequencies within the 2.4 GHz frequency band. The network configurator 112 can also configure the RE 110 to operate the link 124 using frequencies within the 5 GHz frequency band so that the link 124 can couple the RE 110 to the STA 140. When a new STA (such as the STA 142) is added to the wireless network 100, the STA 142 can couple to the RE 110 through the link 126 configured to operate within the 5 GHz frequency band. The configuration of the CAP 104, the RE 106, and the RE 110 described above enables communication between wireless devices without overlapping frequencies in nearby links.

In another example, the network configurator 112 can determine the channel conditions, the configurations and capabilities of the wireless devices (CAP 104, STAs 140-142, REs 106-110) and the desired and current QoS associated with the STAs 140-142. The network configurator 112 can then determine a configuration for the CAP 104, the REs 106-110 and the STAs 140-142 that provides the desired QoS associated with the STAs 140-142. In one embodiment, the network configurator 112 can periodically determine the current QoS associated with the STAs 140-142. If the current QoS is less than the desired QoS for a STA, the network configurator 112 can modify the configuration of the CAP 104, the REs 106-110 and/or the STAs 140-142 to increase the current QoS associated with the respective STA. Thus, the network configurator 112 can respond to changing channel conditions to maintain a desired QoS associated with the STAs 140-142 and enhance the user's experience. The configuration of wireless devices based, at least in part, on channel conditions and a desired QoS will be described in more detail below in conjunction with FIG. 3.

In still another example, if the STA 140 moves, the motion can be detected by one or more REs in the wireless network 100. The network configurator 112 can then configure the network data pathways in response to the detected motion. For example, the STA 140 can move from a first position and stop at a second position, or can move from the first position, through the second position and continue moving in the wireless network 100. The STA 140 (dashed lines in FIG. 1) is coupled to the RE 110 through the link 124. As described above, in one example, that the link 124 is configured to operate within the 5 GHz frequency band. As the STA 140 moves away from the RE 110, the RSSI of a signal from STA 140 measured by the RE 110 can decrease. Similarly, the RE 108 can determine that the STA 140 is approaching the RE 108 through RSSI measurements. If the link 130 is configured to operate within the 2.4 GHz frequency band, then the STA 140 may be re-configured through the network configurator 112 to operate within the 2.4 GHz frequency band and couple to the RE 108. Through this new configuration, the network configurator 112 can ease handover of the STA 140 from the RE 110 to the RE 108. The STA 140 is shown with solid lines to indicate a new position in the wireless network 100. In one embodiment, media access control (MAC) addresses of the CAP 104, the REs 106-110 and the STAs 140-142 can be stored in a database and can be used by the network configurator 112 during handover. For example, the network configurator 112 can use the MAC addresses to identify the REs 106-110 and the STAs 140-142 and to determine the roles of the REs 106-110 and/or the STAs 140-142. The network configurator 112 may also collect link metric information associated with the REs 106-110. For example, the network configurator 112 may collect performance measurements associated with the communication link between the CAP 104 and each of the REs 106-110.

In one embodiment, the network configurator 112 can detect motion and position of a STA through position information provided by the CAP 104, the REs 106-110 and/or the STAs 140-142. For example, the CAP 104, the REs 106-110 and the STAs 140-142 can use triangulation procedures using wireless signals in the wireless network 100. In another example, global positioning system (GPS) data available from the STAs 140-142 can be used to determine position information. As another example, data associated with other satellite navigation systems (e.g., GLONASS) that is available at the STAs 140-142 can be used to determine position information. As another example, motion sensors implemented on the STAs 140-142 may be used to detect the motion of an STA. After determining the motion and position of a moving STA, the network configurator 112 can prepare for handover by configuring the CAP 104, the REs 106-110 and/or the STAs 140-142 to couple to the moving STA.

Continuing the example of the moving STA above, if the STA 140 is limited to operating within the 5 GHz frequency band (because, for example, the STA 140 is not a DBDC device), then the RE 108, as currently configured, may not be able to couple to the STA 140. The network configurator 112 can determine the configuration of the CAP 104, the RE 108, and the STA 140. The network configurator 112 can configure the RE 108 such that the link 128 operates within the 2.4 GHz frequency band and the link 130 operates within the 5 GHz frequency band. Thus, as the STA 140 moves away from the RE 110, the RE 108 can couple to the STA 140 through the link 130. The user experience is improved since coverage for the STA 140 can become more seamless as the network configurator 112 dynamically reacts to changing conditions and maintains connectivity.

FIG. 2 is a flow diagram 200 illustrating example operations for configuring a wireless device in a wireless network 100. The operations of flow diagram 200 are described with reference to the wireless network 100 for illustration purposes and not as a limitation. The example operations can be performed by one or more components of a wireless device in the wireless network 100; for example, the operations can be performed by one or more of a network interface, a processor, and a memory of the wireless device.

The flow can begin at block 202 where the device capabilities of a first wireless device are determined. The first wireless device can be a DBDC device. Referring to FIG. 1, the network configurator 112 can determine the device capabilities of a DBDC device, such as the CAP 104 or the RE 106, in the wireless network 100. Thus, in one example, the first wireless device may be the CAP 104. In another embodiment, the first wireless device may be the RE 106. The first wireless device capabilities can include operating frequencies and channels that are available for use by the first transceiver and the second transceiver in the first wireless device. The flow continues to block 204.

At block 204, the configurations of a second and a third wireless device are determined. The configuration of a wireless device can include information describing frequency and channel usage by the wireless device for wireless communications. For example, the network configurator 112 can determine the frequency band and channel used by the second wireless device and the third wireless device. In one example, the second wireless device can be the CAP 104 and the third wireless device can be the STA 140. The network configurator 112 can determine that the CAP 104 is configured to operate on a channel within the 2.4 GHz frequency band. The network configurator 112 can determine that the STA 140 is configured to operate on a channel within the 5 GHz frequency band. The flow can continue to block 206.

At block 206, the first wireless device is configured to couple network data between the first wireless device and the second wireless device. For example, if the first wireless device is the RE 106 and the second wireless device is the CAP 104, the RE 106 can be configured to couple network data between the RE 106 and the CAP 104. In one embodiment, the first transceiver of the first wireless device can be configured to couple the first wireless device to the second wireless device. In this manner, the first transceiver can couple the network data between the first wireless device and the second wireless device.

In one embodiment, the network configurator 112 can configure the first transceiver based, at least in part, on the device capabilities of the first transceiver and the configuration of the second wireless device. For example, the network configurator 112 can determine that the first transceiver is able to operate within the 5 GHz band, and that the second wireless device is configured to operate within the 5 GHz frequency band. Thus, the network configurator 112 can configure the first transceiver to operate within at least a portion of the 5 GHz frequency band available to the second wireless device and to couple to the second wireless device. The flow continues to block 208.

At block 208, the first wireless device is configured to couple network data between the first wireless device and the third wireless device. For example, if the first wireless device is the RE 106 and the third wireless device is the STA 140, the RE 106 can be configured to couple network data between the RE 106 and the STA 140. In one embodiment, the second transceiver of the first wireless device can be configured to couple the first wireless device to the third wireless device. For example, the network configurator 112 can determine that the second transceiver is able to operate within the 2.4 GHz band, and that the third wireless device is configured to operate within the 2.4 GHz frequency band. The network configurator 112 can configure the second transceiver to operate within at least a portion of the 2.4 GHz frequency band available to the third wireless device and to couple to the third wireless device. In this manner, the second transceiver can couple the network data between the first wireless device and the third wireless device. Thus, the configuration of the first transceiver and the second transceiver can couple the network data between the second wireless device and the third wireless device. After block 208, the flow ends.

The configuration of the first wireless device can also be based on channel conditions in the wireless network 100 and a quality of service associated with at least one of the wireless devices coupled to the first wireless device. The configuration of the first wireless device based, at least in part, on the QoS, channel conditions and wireless device capabilities will be discussed in more detail below in conjunction with FIG. 3.

FIG. 3 is a flow diagram 300 illustrating another embodiment of example operations for configuring a wireless device in a wireless network 100. Example operations can begin in block 302 where channel conditions are determined. As described above, channel conditions can include information regarding wireless channels available to wireless devices in the wireless network 100. Channel conditions can include, but are not limited to, information regarding channel loading (congestion, occupancy), established link speed (data throughput rate within a link), interferers, blockers, and STA mobility. In some embodiments, channel conditions can be determined through spectral scans provided by the wireless devices such as the CAP 104 and the REs 106-110. Spectral scans can determine whether wireless frequencies are busy, noisy or if they contain interferers or blockers. Spectral scans can be performed by hardware included in the wireless devices. In another embodiment, the network analysis unit 160 can perform the spectral scans or can receive channel condition information (such as spectral scan information) from other wireless devices such as the CAP 104 or the REs 106-110. The network analysis unit 160 can be included within a wireless device such as the CAP 104 or one of the REs 106-110 or within the alternate network configurator 150. Flow can proceed to block 304.

In block 304, device capabilities of a first wireless device are determined. As described above, the first wireless device can be a DBDC device. For example, the network configurator 112 can determine the device capabilities of the DBDC device. In one example, the first wireless device may be the RE 106. As another example, the first wireless device may be the CAP 104 of the wireless network 100. The first wireless device capabilities can include operating frequencies and channels that are available for use by the first transceiver and the second transceiver. For example, the first wireless device capabilities can include operating the first transceiver within the 5 GHz frequency band and the second transceiver within the 2.4 GHz frequency band. The flow continues to block 306.

At block 306, the configurations of a second and a third wireless device are determined. The configuration of a wireless device can include information describing frequency and channel usage by the wireless device for wireless communications. For example, the configuration of the second wireless device can include frequency and channel information related to the operation of the second wireless device. In one example, the second wireless device can be the CAP 104 and the third wireless device can be the STA 140. The flow continues to block 308.

At block 308, the desired QoS associated with the second and/or the third wireless device is determined. In one embodiment, the desired QoS can be a desired data throughput rate. In some implementations, the desired data throughput rate can be based, at least in part, on one or more applications currently executing (or planned to be executed) on the second and/or the third wireless device. In another embodiment, the desired QoS can be one or more of a signal-to-noise ratio, a bit error rate, or a data latency time. Flow continues to block 310.

At block 310, the first wireless device is configured to couple network data between the first wireless device and the second wireless device. For example, if the first wireless device is the RE 106 and the second wireless device is the CAP 104, the RE 106 can be configured to couple network data between the RE 106 and the CAP 104. In one embodiment, the first transceiver can be configured to couple the first wireless device to the second wireless device. In this manner, the first transceiver can couple the network data between the first wireless device and the second wireless device.

As described above, the network configurator 112 can configure the first transceiver based, at least in part, on the device capabilities of the first transceiver and the configuration of the second wireless device. In addition, the configuration of the first transceiver can be based, at least in part, on the desired QoS associated with the second wireless device and the channel conditions in the wireless network 100. In one embodiment, the network configurator 112 can select a frequency and channel for the first transceiver that can support a data throughput rate related to the desired QoS. The network configurator 112 can also select a frequency and channel for the first transceiver that avoids congested channel conditions.

For example, the network configurator 112 can determine that the first transceiver is able to operate within the 5 GHz frequency band, and that the second wireless device is configured to operate within the 5 GHz frequency band. The network configurator 112 can also determine that a channel within the 5 GHz frequency band can have relatively good channel conditions (e.g., no interference or blockers detected) and can support the desired QoS associated with the second wireless device. Thus, the network configurator 112 can configure the first transceiver to couple to the second wireless device within at least a portion of the 5 GHz frequency band available to the second wireless device. The flow continues to block 311.

At block 311, the first wireless device is configured to couple network data between the first wireless device and the third wireless device. For example, if the first wireless device is the RE 106 and the third wireless device is the STA 140, the RE 106 can be configured to couple network data between the RE 106 and the STA 140. In one embodiment, the second transceiver of the first wireless device can be configured to couple the first wireless device to the third wireless device. For example, the network configurator 112 can configure the second transceiver based, at least in part, on the device capabilities of the second transceiver, the configuration of the third wireless device, the channel conditions, and the desired QoS associated with the third wireless device. The second transceiver can be configured to operate in a least a portion of the frequency band available to the third wireless device. When the first transceiver and the second transceiver are configured as described above, the network data can be coupled between the second wireless device and the third wireless device via that first wireless device and the flow continues to block 312. In another embodiment, the configuration of the first wireless device can also be based, at least in part, on weighting of the channel conditions and/or wireless device configurations. In still another embodiment, the configuration of the first wireless device can be based, at least in part, on traffic shaping and a partial shutdown of the first wireless device. The configuration of the first wireless device based on weighed channel and device conditions, traffic shaping and partial shutdown will be described in more detail below.

In one embodiment, the configuration of the first wireless device can be determined by a relative weighting of two or more of the channel conditions, the device capabilities of the first wireless device and/or a desired QoS associated a STA. For example, a channel condition describing a link data throughput rate can be relatively more important compared to a channel condition of detected interference to determine the configuration of the first wireless device. That is, the first wireless device can be configured to use a frequency or channel based primarily on a link data throughput rate and secondarily on the detected interference. In another example, the desired QoS associated with the second wireless device can be relatively more important compared to a channel condition describing detected interference to determine the configuration of the first wireless device. Therefore, a higher weighting can be given to a channel condition rather than a device capability when determining the configuration of the first wireless device. For example, a channel condition indicating relatively low amounts of detected interference can be weighted higher than operating within the 5 GHz frequency band when determining the configuration of the first wireless device.

In another embodiment, the configuration of the first wireless device can be determined by a relative preference (weight) of some configuration arrangements over others. For example, operating within the 5 GHz frequency can be preferred over operating within the 2.4 GHz frequency. Thus, configuring the first wireless device to operate within the 5 GHz frequency band can be preferred over configuring the first wireless device to operating within the 2.4 GHz frequency band. In another example, a particular wireless device can be preferred with respect to another wireless device. For example, the first wireless device can be providing network data to a first STA that is streaming a movie and a second STA that is displaying web browser data. The first wireless device can be configured to provide more network data to the first STA relative to the second STA to support higher data throughput rates associated with movie streaming.

In still another embodiment, the configuration of the first wireless device can enable traffic shaping of the network data to and from the STAs 140-142. Traffic shaping can increase network data transmission efficiency. When the network data is transmitted in the wireless network 100, each network data transmission can include some network protocol overhead. For example, the overhead can include preamble and post-amble sequences that are transmitted with each network data transmission. If many smaller network data packets are transmitted, then the related overhead sequences can reduce the efficiency of the data transmissions. Traffic shaping can reduce the effect of the overhead sequences configuring the first wireless device by buffering several network data packets, combining them, and sending an aggregated network data packet. In another embodiment, traffic shaping can also include data throttling. Traffic shaping by data throttling controls the data throughput rate of a data stream so that any one data stream does not overwhelm a link. Traffic shaping can increase the QoS associated with STAs by making more efficient use of data transmission time. In some implementations, the configuration unit 162 can configure the CAP 104, the REs 106-110 and the STAs 140-142 to provide data shaping.

In still another embodiment, the configuration of the first wireless device can also include powering down or disabling at least a portion of the first transceiver and/or the second transceiver. For example, by disabling a portion of a transceiver, the network configurator 112 can remove a source of wireless interference that may be decreasing the performance of a nearby wireless device. Removing or reducing the wireless interference may increase data throughput rates. In some implementations, the configuration unit 162 can power down or disable a portion of the first wireless device, such as a portion of the first transceiver and/or a portion of the second transceiver. For example, powering down the first transceiver in a DBDC device can reduce traffic or interference within a frequency band. The reduced interference can improve data throughput rates through other wireless devices that operate within the frequency band of the disabled transceiver. Operation of the DBDC device, including powering down a portion of the DBDC device will be described in more detail below in conjunction with FIG. 4.

In still another embodiment, the network configurator 112 can configure two or more of the STAs for direct communications. Direct communication between STAs enables a first STA to transfer data with a second STA without data passing through REs 106-110 or CAP 104. Using direct communications can reduce network loading on links within the wireless network 100. In some implementations, the configuration unit 162 can configure two or more STAs for direct communication.

Returning to the flow diagram 300, at block 312, the current QoS associated with the second and/or third wireless device in the wireless network 100 is determined. As described above, the current QoS can be based, at least in part, on a current data throughput rate for network data at the respective wireless devices. In one embodiment, the current QoS can be determined and reported by the STAs 140-142. In another embodiment, the current QoS can be determined by the REs 106-110 or CAP 104 that provide data to the STAs 140-142. The flow continues to block 314.

At block 314, if the current QoS is less than the desired QoS associated with the second and/or third wireless device, then the flow returns to block 302. For example, if the current QoS for the third wireless device (determined at block 312) is less than the desired QoS of the third wireless device (determined at block 308), the configuration of the first wireless device can be changed or updated to increase the current QoS. In this case, the flow returns to block 302 to determine the channel conditions in the wireless network 100. The flow continues to blocks 304-311 to determine a changed or updated configuration of the first wireless device. If the current QoS is greater than or equal to the desired QoS, then the flow can return to block 312. In this case, the configuration of the first wireless device can provide sufficient performance to provide the desired QoS.

FIG. 4 is an example block diagram of a dual band, dual concurrent (DBDC) wireless device 400. In some embodiments, the DBDC wireless device 400 can be the CAP 104 or an RE such as the RE 106. The DBDC wireless device 400 can include a first transceiver 401 and a second transceiver 402. The first transceiver 401 and the second transceiver 402 can be configured to act independently and communicate with other REs or STAs. The transceivers can be divided into a radio unit and a processing unit. The processing unit can be configured to process and encode network data. For example, the processing unit can be configured to add preamble and post-amble sequences to data to generate encoded network data. In another embodiment, the processing unit can be configured to generate encoded network data in accordance with an IEEE 802.11 specification. The radio unit can be configured to transmit the encoded network data to other wireless devices. For example, the radio unit can be configured to amplify the encoded network data for wireless signal transmission.

As depicted in FIG. 4, the first transceiver 401 includes a first radio unit 410 and a first processing unit 412 and the second transceiver 402 includes a second radio unit 420 and a second processing unit 422. Each radio unit 410 and 420 can include a transmitter and a receiver. For example, the first radio unit 410 can include a first transmitter and a first receiver (not shown) and the second radio unit 420 can include a second transmitter and a second receiver (not shown). Each transmitter can be configured to transmit radio signals that include network data. Similarly, each receiver can be configured to receive radio signals that include network data. The first transceiver 401 is coupled to the second transceiver 402 through a data link 440. The data link 440 enables the transfer of data between the transceivers. For example, a first link (not shown) that is provided through the first transceiver 401 can convey data through the data link 440 to the second transceiver 402 and through a second link (not shown) provided through the second transceiver 402. In some embodiments, the links can be serving links or backhaul links as described above in conjunction with FIG. 1.

Since the first transceiver 401 is independent from the second transceiver 402, one of the two transceivers or a portion of one of the transceivers can be disabled or turned off. In one embodiment, the station portion of the transceiver may be disabled or turned off. Disabling a portion of a transceiver can reduce wireless traffic in a particular frequency band, which can improve channel conditions for other nearby REs or STAs. For example, if the second radio unit 420 is disabled, the network data from the second processing unit 422 can traverse the data link 440 and can be carried through the first radio unit 410. Wireless transmissions from the second radio unit 420 could be eliminated and channel conditions in the frequency bands previously used by the second radio unit 420 could be improved.

It should be understood that FIGS. 1-4 and the operations described herein are examples meant to aid in understanding embodiments and should not be used to limit embodiments or limit scope of the claims. Embodiments may perform additional operations, fewer operations, operations in a different order, operations in parallel, and some operations differently. For example, referring back to FIG. 3, device capabilities in block 304 can be determined before determining channel conditions in block 302.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be used. The computer readable medium may be a computer readable storage medium. A computer readable storage medium may be, for example, an electronic, magnetic, optical, electromagnetic, infrared, or semiconductor system, apparatus, or device, or any suitable combination of the foregoing. More specific examples of the computer readable storage medium may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The computer readable medium can include instructions for carrying out operations for aspects of the present disclosure and may be written in any combination of one or more programming languages. Examples of programming languages can include an object oriented programming language such as Java, Smalltalk, C++, or the like and conventional procedural programming languages, such as the “C” programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to be executed.

The computer program instructions can be executed to direct a computer, other programmable data processing apparatus, or other devices to function in a particular manner in order to produce an article of manufacture including instructions, which implement the function/act specified in the flowchart and/or block diagram block or blocks.

The computer program instructions may also be loaded onto a computer, other programmable data processing apparatus, or other devices. The computer program instructions can be executed to cause a series of operational steps to be performed to produce a computer implemented process such that the executed instructions can provide processes for implementing the functions/acts specified in the flowchart and/or block diagram block or blocks.

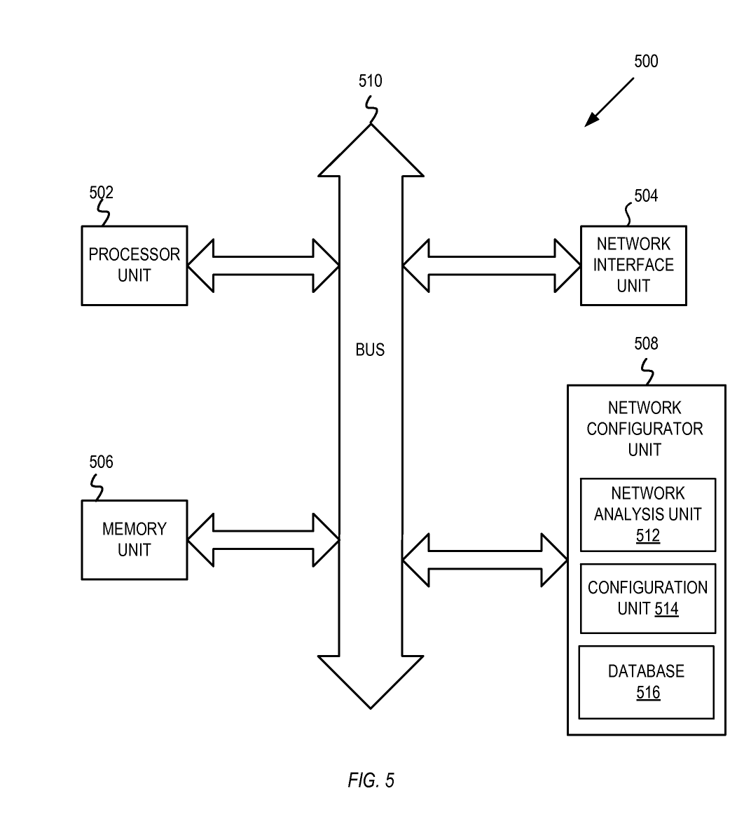

FIG. 5 is a block diagram of an embodiment of an electronic device 500 including a network configurator unit 508. In some implementations, the electronic device 500 may be one of a laptop computer, a tablet computer, a mobile phone, a powerline communication device, a smart appliance (PDA), an access point, a range extender, a wireless station or other electronic systems. The electronic device 500 can include a processor unit 502 (possibly including multiple processors, multiple cores, multiple nodes, and/or implementing multi-threading, etc.). The electronic device 500 can also include a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 500 can also include a bus 510 (e.g., PCI, ISA, PCI-Express, HyperTransport®, InfiniBand®, NuBus, AHB, AXI, etc.), and a network interface unit 504 that can include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, the electronic device 500 may support multiple network interfaces—each of which is configured to couple the electronic device 500 to a different communication network.

The network interface unit 504 can include wireless transceivers such as the first transceiver 401 and the second transceiver 402 described in FIG. 4 above. In some embodiments, portions of the network configurator 112, described in FIG. 1, can be distributed within the processor unit 502, the memory unit 506, and the bus 510.

The network configurator unit 508 can perform some or all of the operations described in FIGS. 1-4 above. Although shown separately in FIG. 5, in some embodiments, the network configurator unit 508 can be included in the network interface unit 504 or can be implemented by the processor unit 502 executing computer program instructions stored in the memory unit 506. The network configurator unit 508 can include a network analysis unit 512 and a configuration unit 514. The network analysis unit 512 can determine channel conditions, desired and current QoS, and the configuration and the capabilities of the CAP 104, the REs 106-110 and the STAs 140-142. The network analysis unit 512 can operate similarly to the network analysis unit 160 described above. The configuration unit 514 can configure the CAP 104, the REs 106-110 and the STAs 140-142 to establish the links as determined by the network configurator unit 508. The configuration unit 514 can operate similarly to the configuration unit 162 described above. The network configurator unit 508 can also include a database 516 containing device configurations and capabilities and MAC addresses or other information as described in conjunction with FIGS. 1-4 above.

The memory unit 506 can include computer instructions executable by the processor unit 502 to implement the functionality of the embodiments described in FIGS. 1-4 above. In one embodiment, the memory unit 506 can include instructions to configure the CAP 104 and the RE 106-110 settings in accordance with determined channel conditions, determined desired QoS, current QoS and the capabilities and configurations of the CAP 104, the REs 106-110 and the STAs 140-142. Any one of these functionalities may be partially (or entirely) implemented in hardware and/or on the processor unit 502. For example, the functionality may be implemented with an application specific integrated circuit, in logic implemented in the processor unit 502, in a co-processor on a peripheral device or card, etc. Further, realizations may include fewer or additional components not illustrated in FIG. 5 (e.g., video cards, audio cards, additional network interfaces, peripheral devices, etc.). The processor unit 502, the memory unit 506, the network interface unit 504, and the network configurator unit 508 are coupled to the bus 510. Although illustrated as being coupled to the bus 510, the memory unit 506 may be coupled to the processor unit 502.

While the embodiments are described with reference to various implementations and exploitations, it will be understood that these embodiments are illustrative and that the scope of the disclosure is not limited to them. In general, techniques for network configuration as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
determining, at a network configurator, a first device capability of a first wireless transceiver of a first device and a second device capability of a second wireless transceiver of the first device;
determining a configuration of a second device and a configuration of a third device;
configuring the first wireless transceiver to couple network data between the first device and the second device via a first range of frequencies, wherein the first range of frequencies is based, at least in part, on the first device capability and the configuration of the second device; and
configuring the second wireless transceiver to couple network data between the first device and the third device via a second range of frequencies, wherein the second range of frequencies is based, at least in part, on the second device capability and the configuration of the third device.

2. The method of claim 1, further comprising configuring a data link to couple network data between the first wireless transceiver and the second wireless transceiver.

3. The method of claim 2, further comprising:
disabling a first transmitter of the first wireless transceiver;
configuring the second wireless transceiver to receive the network data from the data link coupled to the first wireless transceiver; and
transmitting, by a second transmitter of the second wireless transceiver, the network data to the third device via the second range of frequencies.

4. The method of claim 1, wherein the configuration of the second device includes operating frequencies available to the second device and the configuration of the third device includes operating frequencies available to the third device.

5. The method of claim 4, wherein the first range of frequencies includes at least a portion of the operating frequencies available to the second device, wherein the second range of frequencies includes at least a portion of the operating frequencies available to the third device.

6. The method of claim 1, further comprising:
determining a desired quality of service associated with the third device,
wherein configuring the second wireless transceiver is based, at least in part, on the desired quality of service associated with the third device.

7. The method of claim 6, wherein the desired quality of service is based, at least in part, on an application to be executed on the third device.

8. The method of claim 6, further comprising:
determining whether a current quality of service associated with the third device is less than the desired quality of service,
wherein configuring the second wireless transceiver to couple the network data between the third device and the first device is based, at least in part, on determining whether the current quality of service is less than the desired quality of service.

9. The method of claim 6, wherein the desired quality of service is based on at least one of a data throughput rate, a bit error rate, a data latency time and a signal-to-noise ratio.

10. The method of claim 1, further comprising:
determining a first channel condition associated with a first channel available to the first wireless transceiver and determining a second channel condition associated with a second channel available to the second wireless transceiver,
wherein configuring the first wireless transceiver is based, at least in part, on the first channel condition and configuring the second wireless transceiver is based, at least in part, on the second channel condition.

11. The method of claim 1, further comprising:
determining whether the third device is moving away from the first device and toward the second device; and
configuring the second device to couple network data between the third device and the second device in response to determining that the third device is moving away from the first device and toward the second device.

12. The method of claim 11, wherein determining whether the third device is moving away from the first device and toward the second device is based, at least in part, on at least one of received signal strength measurements associated with signals transmitted by the third device, satellite navigation data received by the third device, and a motion sensor implemented on the third device.

13. The method of claim 1, further comprising:
determining whether the third device is moving away from the first device and toward a fourth device; and
configuring the fourth device to couple network data between the third device and the fourth device in response to determining whether the third device is moving away from the first device and toward the fourth device.

14. The method of claim 1, wherein the network configurator is included in one of the first device, the second device, and the third device.

15. The method of claim 1, further comprising:
configuring the first wireless transceiver to operate within a 2.4 GHz frequency band; and
configuring the second wireless transceiver to operate within a 5.0 GHz frequency band.

16. A first device comprising:
a first wireless transceiver;
a second wireless transceiver;
a network configurator configured to:
determine a first device capability of the first wireless transceiver and a second device capability of the second wireless transceiver;
determine a configuration of a second device and a configuration of a third device;
determine a configuration of the first wireless transceiver to couple network data between the first device and the second device via a first range of frequencies, wherein the first range of frequencies is based, at least in part, on the first device capability and the configuration of the second device; and
determine a configuration of the second wireless transceiver to couple network data between the first device and the third device via a second range of frequencies, wherein the second range of frequencies is based, at least in part, on the second device capability and the configuration of the third device.

17. The first device of claim 16, further comprising a data link configured to couple network data between the first wireless transceiver and the second wireless transceiver.

18. The first device of claim 17, wherein the network configurator is further configured to:
disable a first transmitter of the first wireless transceiver;
configure the second wireless transceiver to receive the network data from the data link coupled to the first wireless transceiver; and
transmit, by a second transmitter of the second wireless transceiver, the network data to the third device via the second range of frequencies.

19. The first device of claim 16, wherein the network configurator is configured to determine the configuration of the first wireless transceiver based, at least in part, on operating frequencies available to the second device and determine the configuration of the second wireless transceiver based, at least in part, on operating frequencies available to the third device.

20. The first device of claim 19, wherein the first range of frequencies includes at least a portion of the operating frequencies available to the second device, wherein the second range of frequencies includes at least a portion of the operating frequencies available to the third device.

21. The first device of claim 16, wherein the network configurator is configured to determine the configuration of the first wireless transceiver based, at least in part, on a desired quality of service associated with the second device.

22. The first device of claim 21, wherein the network configurator is configured to determine the desired quality of service associated with the second device.

23. The first device of claim 21, wherein the network configurator is configured to:
determine whether a current quality of service associated with the second device is less than the desired quality of service for the second device; and
determine the configuration of the first wireless transceiver based, at least in part, on whether the current quality of service is less than the desired quality of service.

24. The first device of claim 16, wherein the network configurator is further configured to configure at least one of the first wireless transceiver and the second wireless transceiver based, at least in part, on a channel condition associated with a communication channel.

25. A device comprising:
a first transceiver including a first transmitter configured to transmit a first network data via a first frequency range;
a second transceiver including a second transmitter configured to transmit a second network data via a second frequency range; and
a data link configured to couple the first network data from the first transceiver to the second transceiver to transmit the first network data via the second transmitter when the first transmitter is disabled.

26. The device of claim 25, wherein the first transmitter is disabled when interference is present within operating frequencies of the first transceiver.

27. The device of claim 25, wherein the data link is configured to couple the second network data from the second transceiver to the first transceiver to transmit the second network data via the first transmitter when the second transmitter is disabled.

28. A non-transitory machine-readable storage medium having machine executable instructions stored therein, the machine executable instructions comprising instructions to:
determine, at a network configurator, a first device capability of a first wireless transceiver of a first device and a second device capability of a second wireless transceiver of the first device;
determine a configuration of a second device and a configuration of a third device;
configure the first wireless transceiver to couple network data between the first device and the second device via a first range of frequencies, wherein the first range of frequencies is based, at least in part, on the first device capability and the configuration of the second device; and
configure the second wireless transceiver to couple network data between the first device and the third device via a second range of frequencies, wherein the second range of frequencies is based, at least in part, on the second device capability and the configuration of the third device.

29. The non-transitory machine-readable storage medium of claim 28, further comprising instructions to:
configure a data link to couple network data between the first wireless transceiver and the second wireless transceiver.

30. The non-transitory machine-readable storage medium of claim 29, further comprising instructions to:
disable a first transmitter of the first wireless transceiver;
configure the second wireless transceiver to receive the network data from the data link coupled to the first wireless transceiver; and
transmit, by a second transmitter of the second wireless transceiver, the network data to the third device via the second range of frequencies.
